(19) United States
(12) Patent Application Publication
(10) Pub. No.: US 2025/0070945 A1
(43) Pub. Date: Feb. 27, 2025

(54) MULTI-DCI MULTI-TRP BASED DL TRANSMISSION IN UNIFIED TCI FRAMEWORK

(71) Applicant: LENOVO (BEIJING) LIMITED, Beijing (CN)

(72) Inventors: Bingchao LIU, Beijing (CN); Chenxi ZHU, Fairfax, VA (US); Wei LING, Beijing (CN); Yi ZHANG, Beijing (CN); Lingling XIAO, Beijing (CN)

(21) Appl. No.: 18/726,037

(22) PCT Filed: Jan. 17, 2022
(86) PCT No.: PCT/CN2022/072293

§ 371 Date: Jul. 1, 2024

(51) Int. Cl. H04L 5/00; H04B 7/06; H04W 72/232

(52) U.S. Cl. CPC H04L 5/0053; H04B 7/0626; H04W 72/232

(57) ABSTRACT

Methods and apparatuses for multi-DCI multi-TRP based DL transmission in unified TCI framework are disclosed. In one embodiment, a UE comprises a processor; and a transceiver coupled to the processor, wherein the processor is configured to receive, via the transceiver, an MAC CE including a CORESET pool ID field to activate one or multiple DL or joint TCI states among configured DL or joint TCI states when a high layer parameter CORESETPoolIndex is configured for at least one CORESET; and receive, via the transceiver, a DCI indicating one DL or joint TCI state when multiple DL or joint TCI states are activated.

### FIELD

The subject matter disclosed herein generally relates to wireless communications, and more particularly relates to methods and apparatuses for multi-DCI multi-TRP based DL transmission in unified TCI framework.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), transmission reception point (TRP), Downlink Control Information (DCI), Physical Downlink Shared Channel (PDSCH), Transmission Configuration Indicator or Transmission Configuration Indication (TCI), control resource set (CORESET), Medium Access Control (MAC), MAC control element (MAC CE), Physical Downlink Control Channel (PDCCH), quasi-colocation (QCL), Physical Uplink Shared Channel (PUSCH), Sounding Reference Signal (SRS), Physical Uplink Control Channel (PUCCH), Demodulation Reference Signal (DM-RS), Channel State Information Reference Signal (CSI-RS), band width part (BWP), Semi-persistent scheduling (SPS), Aperiodic (AP), beam management (BM), channel state information (CSI), Physical Cell Identity (PCID), Synchronization Signal Block (SSB), Acknowledge (ACK), Negative Acknowledge (NACK), Hybrid Automatic Repeat request (HARQ), Beam application time (BAT), time domain resource allocation (TDRA), PUCCH resource indicator (PRI), Control channel element (CCE), resource block (RB).

Multi-TRP based DL operation was introduced in NR Release 16 by means of multi-DCI based multi-TRP PDSCH transmission as well as single-DCI based multi-TRP PDSCH transmission. For multi-DCI based multi-TRP PDSCH transmission, each TRP independently transmits a DCI to schedule PDSCH transmission transmitted from that TRP. For single-DCI based multi-TRP PDSCH transmission, one TRP transmits a DCI to schedule a PDSCH transmission transmitted from both TRPs.

Multi-DCI based multi-TRP PDSCH transmission was specified based on NR Release 15 TCI framework, where the TCI state for PDSCH transmission is configured by MAC CE for each CORESET. Up to 128 TCI states for PDSCH transmission can be configured for a UE in a cell by RRC signaling. Up to 8 out of the configured TCI states are activated by a MAC CE. The value (or TCI codepoint) indicated by a TCI field of the DCI is mapped to one of activated TCI states, as a dynamic TCI state indication for the scheduled PDSCH transmission.

In order to reduce beam indication overhead, unified TCI framework was introduced in NR Release 17 for single-TRP operation. For DL (i.e. both PDCCH and PDSCH) transmission, a common TCI state can be indicated by DCI and applied to all the UE-specific PDCCH and PDSCH reception.

This disclosure targets supporting the multi-TRP DL transmission with unified TCI framework.

### BRIEF SUMMARY

Methods and apparatuses for multi-DCI multi-TRP based DL transmission in unified TCI framework are disclosed.

In one embodiment, a UE comprises a processor; and a transceiver coupled to the processor, wherein the processor is configured to receive, via the transceiver, an MAC CE including a CORESET pool ID field to activate one or multiple DL or joint TCI states among configured DL or joint TCI states when a high layer parameter CORESETPoolIndex is configured for at least one CORESET; and receive, via the transceiver, a DCI indicating one DL or joint TCI state when multiple DL or joint TCI states are activated.

In one embodiment, when one DL or joint TCI state is activated by the MAC CE, the one DL or joint TCI state is associated with the CORESETPoolIndex indicated by CORESET pool ID field included in the MAC CE. In another embodiment, when multiple DL or joint TCI states are activated by the MAC CE, the activated multiple DL or joint TCI states are mapped to TCI codepoints indicated by DCI format 1_1 or 1_2 carried by PDCCH received from any CORESET(s) configured with the CORESETPoolIndex value that is the same as that indicated by the CORESET pool ID field included in the MAC CE. In particular, one of the activated multiple DL or joint TCI states is indicated by a DCI format 1_1 or 1_2 carried by PDCCH received from any CORESET configured with CORESETPoolIndex having the same value as that indicated by the CORESET Pool ID field value, and is associated with the same CORESETPoolIndex value configured for the CORESET.

In some embodiment, the processor is further configured to determine the TCI state for PDCCH transmission, PDSCH transmission, SPS PDSCH transmission and AP CSI-RS for beam management or channel state information acquisition according to the CORESETPoolIndex value. In particular, the processor is configured to apply the activated or indicated TCI state to PDCCH transmission and the respective PDSCH transmission received from the CORESET configured with the same CORESETPoolIndex associated with the activated or indicated TCI state; SPS PDSCH transmission activated by a DCI carried by PDCCH received from the CORESET configured with the same CORESETPoolIndex associated with the activated or indicated TCI state; and AP CSI-RS resources for beam management or channel state information acquisition and triggered by a DCI carried by PDCCH received from the CORESET configured with the same CORESETPoolIndex associated with the activated or indicated TCI state, where the CORESET is any CORESET other than CORESET #0 and is associated with only UE-specific search space, wherein, when only one DL or joint TCI state is activated by the MAC CE, the activated or indicated TCI state is the one activated DL or joint TCI state; and when multiple DL or joint TCI states are activated by the MAC CE, the activated or indicated TCI state is the indicated one DL or joint TCI state by the DCI.

In some embodiment, the activated TCI states associated with a CORESETPoolIndex value are associated with different PCID values. In some embodiment, when a single activated or indicated TCI state is associated with a PCID of a non-serving cell, the PDCCH and PDSCH transmissions received from the CORESET having the same CORESETPoolIndex value as the single activated or indicated TCI state are rate matched around SSB associated with the non-serving PCID. In some embodiment, when a single activated or indicated TCI state associated with one CORESETPoolIndex value is associated with a PCID of a non-serving cell, the single activated or indicated TCI state associated with the other CORESETPoolIndex value is associated with the PCID of the serving cell.

In some embodiment, the processor is further configured to transmit, via the transceiver, a UE capability indicates whether reporting HARQ-ACK bit for DCI indicating unified TCI state in a joint HARQ-ACK codebook is supported. In addition, the processor is further configured to receive, via the transceiver, a configuration with two BAT values for a cell when the UE capability indicates that reporting the HARQ-ACK bit for DCI indicating TCI state in a joint HARQ-ACK codebook is supported, where one BAT value is for separate ACK/NACK feedback and the other BAT value is for joint ACK/NACK feedback, or one BAT value is for separate ACK/NACK feedback and the sum of the one BAT value and the other BAT value is for joint ACK/NACK feedback. In particular, when a joint ACK/NACK feedback mode is configured, if the ACK/NACK bits for DCIs each of which indicates a unified TCI state is reported in a joint HARQ-ACK codebook, the BAT value for joint ACK/NACK feedback is applied; and if the ACK/NACK bit for each DCI indicating a unified TCI state is reported individually, the BAT value for separate ACK/NACK feedback is applied.

In another embodiment, a method at a UE comprises receiving an MAC CE including a CORESET pool ID field to activate one or multiple DL or joint TCI states among configured DL or joint TCI states when a high layer parameter CORESETPoolIndex is configured for at least one CORESET; and receiving a DCI indicating one DL or joint TCI state when multiple DL or joint TCI states are activated.

In still another embodiment, a base unit comprises a processor; and a transceiver coupled to the processor, wherein the processor is configured to transmit, via the transceiver, an MAC CE including a CORESET pool ID field to activate one or multiple DL or joint TCI states among configured DL or joint TCI states; and transmit, via the transceiver, a DCI indicating one DL or joint TCI state when multiple DL or joint TCI states are activated.

In yet another embodiment, a method of a base unit comprises transmitting an MAC CE including a CORESET pool ID field to activate one or multiple DL or joint TCI states among configured DL or joint TCI states when a high layer parameter CORESETPoolIndex is configured for at least one CORESET; and transmitting a DCI indicating one DL or joint TCI state when multiple DL or joint TCI states are activated.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates the activation result according to the first embodiment;

FIG. 2 is a schematic flow chart diagram illustrating an embodiment of a method;

FIG. 3 is a schematic flow chart diagram illustrating an embodiment of another method; and

FIG. 4 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

In NR Release 17 unified TCI framework, joint DL/UL TCI or separate DL/UL TCI can be configured for a cell by RRC signaling.

When separate DL/UL TCI is configured, the DL TCI state for DL reception and UL TCI state for UL transmission are separately indicated. For UL TCI state, the source reference signal in the UL TCI provides a reference for determining UL TX spatial filter at least for dynamic-grant or configured-grant based PUSCH and all of dedicated PUCCH resources, which are the PUCCH resources in RRC-connected mode, in a CC. For DL TCI state, the source reference signal(s) (one source reference signal is contained if only the higher layer parameter qcl-Type1 is configured, and two source reference signals are contained if both the higher layer parameter qcl-Type1 and the higher layer parameter qcl_Type2 are configured) in the DL TCI provides QCL information at least for UE-dedicated reception on PDCCH and all the PDSCHs in a CC. Each CORESET is configured by a set of time-frequency resources for PDCCH reception. In this situation, a PL-RS is associated with the indicated UL TCI state for path loss calculation. UL power control parameters other than PL-RS (e.g. set of P0, alpha and closed loop index) for PUSCH, PUCCH and SRS may also be associated with the indicated UL TCI state.

When joint DL/UL TCI is configured, both UL TCI state for UL transmission and DL TCI state for DL reception are determined by a single indicated joint DL/UL TCI state. When the joint DL/UL TCI state is configured, a joint TCI refers to at least a common source reference RS used for determining both the DL QCL information and the UL TX spatial filter. For example, the UL TX beam and the DL RX beam are both determined by the QCL-TypeD RS configured in the indicated joint DL/UL TCI state.

A brief introduction of the TCI state is provided as follows:

The UE can be configured with a list of up to M TCI-State configurations to decode PDSCH according to a detected PDCCH with DCI intended for the UE and the given serving cell, where M depends on the UE capability. The TCI-state is configured by the following RRC signaling:

The IE TCI-State associates one or two DL reference signals with a corresponding quasi-colocation (QCL) type.

TCI-State information element

| | |
|---|---|
| TCI-State ::= | SEQUENCE { |
| tci-StateId | TCI-StateId, |
| qcl-Type1 | QCL-Info, |
| qcl-Type2 | QCL-Info |

...
}

| | |
|---|---|
| QCL-Info ::= | SEQUENCE { |
| cell | ServCellIndex |
| bwp-Id | BWP-Id |
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

...
}

Each TCI-State contains parameters for configuring a quasi co-location (QCL) relationship between one or two downlink reference signals and the DM-RS ports of the PDSCH, the DM-RS port of PDCCH or the CSI-RS port(s) of a CSI-RS resource. The quasi co-location relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

The UE receives an activation command used to map up to 8 TCI states to the codepoints of the DCI field ‘Transmission Configuration Indication’ (i.e. TCI field) in one DL BWP of a serving cell. When a UE supports two TCI states in a codepoint of the ‘Transmission Configuration Indication’ (TCI) field of a DCI, the UE may receive an activation command, the activation command is used to map up to 8 combinations of one or two TCI states to the codepoints of the TCI field.

A first embodiment relates to intra-cell multi-DCI based multi-TRP DL transmission. Intra-cell multi-TRP means that multiple TRPs (e.g. two TRPs) belong to the same cell.

To support multi-DCI based multi-TRP DL transmission, each CORESET is configured with a higher layer parameter CORESETPoolIndex for TRP differentiation. For example, multiple TRPs (e.g. two TRPs) can be configured for a BWP of a cell for a UE. All the CORESET(s) configured for one TRP may be configured with CORESETPoolIndex=0 and all the CORESET(s) configured for the other TRP may be configured with CORESETPoolIndex=1. When CORESETPoolIndex is not configured for a CORESET, the UE shall assume CORESETPoolIndex=0 for the CORESET. Specifically, when CORESETPoolIndex is configured for at least one CORESET of the active BWP, a CORESET Pool ID field shall be contained in the DL TCI state activation/deactivation MAC CE or the joint TCI state activation/deactivation MAC CE.

Up to 128 DL TCI states or 128 joint TCI states can be configured by RRC signaling for a UE in a BWP according to UE capability. Note that, in the following description, DL TCI state or joint TCI state is referred to as DL or joint TCI state. Up to 8 out of the configured DL or joint TCI states are activated by a MAC CE (e.g. DL TCI state activation/deactivation MAC CE or joint TCI state activation/deactivation MAC CE) for each CORESETPoolIndex. In other words, the DL or joint TCI states should be activated per TRP.

Specifically, when CORESETPoolIndex is configured for at least one CORESET of the active BWP, a CORESET Pool ID field shall be contained in the MAC CE (e.g. the DL TCI state activation/deactivation MAC CE or the joint TCI state activation/deactivation MAC CE). All the activated DL or joint TCI states are associated with a CORESETPoolIndex value indicated by the CORESET Pool ID field included in the MAC CE.

If only one DL or joint TCI state is activated, the activated DL or joint TCI state is associated with the CORESETPoolIndex indicated by the CORESET Pool ID field contained in the MAC CE.

If multiple (e.g. two or more) DL or joint TCI states are activated by the MAC CE, the CORESET Pool ID field indicates the mapping between the activated DL or joint TCI states and the codepoints of the Transmission Configuration Indication (TCI) field contained in DCI format 1_1 or 1_2 carried in PDCCH received from any CORESET(s) configured with a CORESETPoolIndex with the same value as indicated by the CORESET Pool ID field of the MAC CE. The CORESET Pool ID field set to 1 indicates that the activated DL or joint TCI states are mapped to the TCI codepoints indicated by DCI format 1_1 or 1_2 carried by PDCCH received from CORESET(s) configured with CORESETPoolIndex=1, and CORESET Pool ID field set to 0 indicates that the activated DL or joint TCI states are mapped to the TCI codepoints indicated by DCI format 1_1 or 1_2 carried by PDCCH received from CORESET(s) configured with CORESETPoolIndex=0.

If multiple DL or joint TCI states are activated by the MAC CE, one of the activated DL or joint TCI states is further indicated by DCI format 1_1 or 1_2. In particular, one of the activated DL or joint TCI states activated by the MAC CE containing a CORESET Pool ID field is further indicated by DCI format 1_1 or 1_2 carried by PDCCH received from any CORESET configured with CORESETPoolIndex having the same value as that indicated by the CORESET Pool ID field. In this situation, the indicated DL or joint TCI state is associated with the CORESETPoolIndex that is configured for the CORESET transmitting the PDCCH carrying the DCI format 1_1 or 1_2, which is the same value as that indicated by the CORESET Pool ID field included in the MAC CE.

The indicated DL or joint TCI state (when multiple DL or joint TCI states are activated by the MAC CE, and one of the multiple activated DL or joint TCI states is indicated by DCI format 1_1 or 1_2) or the only one activated DL or joint TCI state (when one DL or joint TCI state is activated by the MAC CE) can be collectively abbreviated as “the activated or indicated TCI state” in the following description. The activated or indicated TCI state applies to:
PDCCH transmission and the respective PDSCH transmission received from the CORESET configured with the same CORESETPoolIndex associated with the activated or indicated TCI state (note that the respective PDSCH transmission means the PDSCH transmission scheduled by a DCI carried by the PDCCH transmission), where the CORESET should be other than CORESET #0 and be associated with only UE-specific search space;
Semi-persistent scheduling (SPS) PDSCH transmission activated by a DCI carried by PDCCH received from the CORESET configured with the same CORESETPoolIndex associated with the activated or indicated TCI state, where the CORESET should be other than CORESET #0 and be associated with only UE-specific search space; and
Aperiodic (AP) CSI-RS resources for beam management (BM) or channel state information (CSI) acquisition and triggered by a DCI carried by PDCCH received from the CORESET configured with the same CORESETPoolIndex associated with the activated or indicated TCI state, where the CORESET should be other than CORESET #0 and be associated with only UE-specific search space.

A brief introduction to search space is described. A search space is a set of candidate control channels formed by CCEs at a given aggregation level, which the device is supposed to decode, where a CCE (Control channel element) is a number of RB (resource block) groups in a CORESET. A CORESET identifies a set of time-frequency resources for PDCCH transmission. The number of CCEs used for a PDCCH is referred to as the aggregation level. The search space can be UE-specific search space, which is a search space dedicated for a UE, or common search space, which is a search space for a group of UEs.

An example of the first embodiment is described as follows:

A UE is configured with separate DL/UL TCI framework. 128 DL TCI states, e.g., DL TCI-State #0, DL TCI-State #1, . . . , DL TCI-State #127, are configured for a BWP. CORESETPoolIndex with value 0 (CORESETPoolIndex=0) is configured for CORESET #1, CORESET #2 and CORESET #3, and CORESETPoolIndex with value 1 (CORESETPoolIndex=1) is configured for CORESET #4 and CORESET #5.

CORESET #1 is associated only with common search space. CORESET #2, CORESET #3, CORESET #4 and CORESET #5 are associated with UE-specific search space.

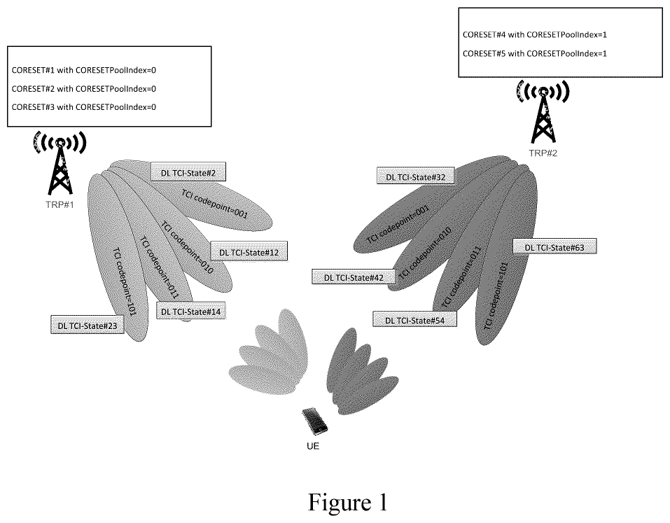

The UE receives a MAC CE (e.g. the DL TCI state activation/deactivation MAC CE) including CORESET pool ID field equal to 0 that activates DL TCI-State #2 for TCI codepoint 001, DL TCI-State #12 for TCI codepoint 010, DL TCI-State #14 for TCI codepoint 011, and DL TCI-State #23 for TCI codepoint 101. The UE also receives another MAC CE including CORESET pool ID field equal to 1 that activates DL TCI-State #32 for TCI codepoint 001, DL TCI-State #42 for TCI codepoint 010, DL TCI-State #54 for TCI codepoint 011, and DL TCI-State #63 for TCI codepoint 101. FIG. 1 illustrates the activation result.

If the UE receives a DCI format 1_1 with TCI field value (i.e. TCI codepoint) 010 from CORESET #2 (having CORESETPoolIndex=0), DL TCI-State #12 is indicated as the DL TCI state associated with CORESETPoolIndex=0. According to the first embodiment, the indicated DL TCI state (i.e. DL TCI-State #12) associated with CORESETPoolIndex=0 shall be applied to:
PDCCH transmission and the respective PDSCH transmission received from CORESET #2 or CORESET #3;
SPS PDSCH transmission activated by DCI carried by PDCCH received from CORESET #2 or CORESET #3;
AP CSI-RS resources configured with higher layer parameter repetition (implying that it is AP CSI-RS resources for BM) and triggered by DCI carried by PDCCH received from CORESET #2 or CORESET #3; and
AP CSI-RS resources configured without higher layer parameter repetition and without trs-info (implying that it is AP CSI-RS resources for CSI acquisition) and triggered by DCI carried by PDCCH received from CORESET #2 or CORESET #3. The higher layer parameter repetition can only be configured for the CSI-RS resource used for BM and indicates whether the CSI-RS resource is transmitted with repetition. The higher layer parameter trs-info indicates a CSI-RS resource is used for tracking.

If the UE receives a DCI format 1_2 with TCI field value (i.e. TCI codepoint) 010 from CORESET #5 (having CORESETPoolIndex=1), DL TCI-State #42 is indicated as the DL TCI state associated with CORESETPoolIndex=1. According to the first embodiment, the indicated DL TCI state (i.e. DL TCI-State #42) associated with CORESETPoolIndex=1 shall be applied to:
PDCCH transmission and the respective PDSCH transmission received from CORESET #4 or CORESET #5;
SPS PDSCH transmission activated by DCI carried by PDCCH received from CORESET #4 or CORESET #5;
AP CSI-RS resources configured with higher layer parameter repetition (implying that it is AP CSI-RS resources for BM) and triggered by DCI carried by PDCCH received from CORESET #4 or CORESET #5; and
AP CSI-RS resources configured without higher layer parameter repetition and without trs-info (implying that it is AP CSI-RS resources for CSI acquisition) and triggered by DCI carried by PDCCH received from CORESET #4 or CORESET #5.

A second embodiment relates to multi-DCI based multi-TRP DL transmission in inter-cell multi-TRP operation.

In intra-cell multi-TRP operation, all configured TCI states can only be associated with SSB from the serving cell. Inter-cell beam management was supported in NR Release 17, where SSB associated with a PCID different from the PCID associated with the serving cell can be configured in TCI state for DL beam indication as well as UL beam indication. That is, the configured TCI states may be associated with additional PCIDs different from serving cell PCID.

When an indicated or activated TCI state (when only one DL or joint TCI state is activated by the MAC CE, the activated or indicated TCI state is the one activated DL or joint TCI state; and when multiple DL or joint TCI states are activated by the MAC CE, the activated or indicated TCI state is the indicated one DL or joint TCI state by the DCI) associated with a non-serving PCID applies to PDSCH and PDCCH transmissions, the PDSCH and PDCCH transmissions received from a TRP associated with the non-serving PCID should be rate matched around non-serving SSB associated with the same non-serving PCID, since the non-serving SSB associated with the non-serving PCID may be ignored by the UE when the UE only receives PDSCH and PDCCH transmissions from the TRP associated with the same non-serving PCID in an inter-cell multi-TRP DL transmission. Rate matching around the SSB pattern means that the RE used for SSB transmission cannot be used for PDCCH and PDSCH transmission and the UE should avoid those REs when perform resource mapping.

The SSBs from different cells (e.g. different non-serving cells) have different patterns, i.e., different SSBs from different cells may occupy different time-frequency resources. It means that rate matching pattern switching time is necessary when the UE switches from receiving PDSCH and PDCCH transmissions from one TRP associated with one non-serving PCID to receiving PDSCH and PDCCH transmissions from another TRP associated with another non-serving PCID (e.g. when the indicated or activated TCI state changes).

When unified TCI framework is configured, an indicated new TCI state by DCI format 1_1 or 1_2 shall be applied to all UE-dedicated PDCCH transmissions and the respective PDSCH transmissions in the cell after the beam application time (BAT) from the reception of DCI format 1_1 or 1_2 indicating the new TCI state. The BAT is configured by gNB according to UE capability reporting. If the rate matching pattern switching time can be contained in the BAT, DCI based rate matching pattern switching can be enabled. Accordingly, to support inter-cell multi-TRP operation, the reported UE capability on BAT should include the rate matching pattern switching time. Incidentally, the BAT is only related to the indicated new TCI state by DCI and is not related to the single new TCI state activated by MAC CE.

According to the second embodiment, when unified TCI framework is configured for a cell configured with different CORESETPoolIndex values for different CORESETs, the configured TCI states associated with a CORESETPoolIndex value can be associated with different PCIDs according to UE capability on whether supporting that the configured TCI states (associated with a CORESETPoolIndex value) can be associated with different PCIDs.

When the configured TCI states associated with a CORESETPoolIndex value can be associated with different PCIDs, the PDCCH and PDSCH transmissions received from a TRP associated with a non-serving PCID are rate matched around the SSB associated with the same non-serving PCID.

An example of the second embodiment is as follows.

A UE is configured with separate DL/UL TCI framework. 128 DL TCI states, e.g., DL TCI-State #0, DL TCI-State #1, . . . , DL TCI-State #127, are configured for a BWP. CORESETPoolIndex with value 0 (CORESETPoolIndex=0) is configured for CORESET #1, CORESET #2 and CORESET #3, and CORESETPoolIndex with value 1 (CORESETPoolIndex=1) is configured for CORESET #4 and CORESET #5.

CORESET #1 is associated only with common search space. CORESET #2, CORESET #3, CORESET #4 and CORESET #5 are associated with UE-specific search space.

The UE receives a MAC CE (e.g. the DL TCI state activation/deactivation MAC CE) including CORESET pool ID field equal to 0 that activates DL TCI-State #2 for TCI codepoint 001, DL TCI-State #12 for TCI codepoint 010, DL TCI-State #14 for TCI codepoint 011, and DL TCI-State #23 for TCI codepoint 101. All of DL TCI-State #2, DL TCI-State #12, DL TCI-State #14, and DL TCI-State #23 are associated with serving cell PCID.

The UE also receives another MAC CE including CORESET pool ID field equal to 1 that activates DL TCI-State #32 for TCI codepoint 001, DL TCI-State #42 for TCI codepoint 010, DL TCI-State #54 for TCI codepoint 011, and DL TCI-State #63 for TCI codepoint 101. DL TCI-State #32 is associated with PCID #1, DL TCI-State #42 is associated with PCID #2, DL TCI-State #54 is associated with PCID #3 and DL TCI-State #63 is associated with PCID #4. All of PCID #1, PCID #2, PCID #3 and PCID #4 are PCIDs of non-serving cells.

If the UE receives a DCI format 1_1 with TCI field value (i.e. TCI codepoint) 010 from CORESET #2 (having CORESETPoolIndex=0), the TCI field value 010 indicates DL TCI-State #12 as the DL TCI state for CORESETPoolIndex=0. Since DL TCI-State #12 is associated with the serving cell PCID, the PDSCH and PDCCH transmissions associated with CORESETPoolIndex=0 shall perform rate matching around the SSB associated with the serving cell PCID.

If the UE receives a DCI format 1_2 with TCI field value (i.e. TCI codepoint) 010 from CORESET #5 (having CORESETPoolIndex=1), the TCI field value 010 indicates DL TCI-State #42 as the DL TCI state for CORESETPoolIndex=1. Accordingly, all the PDCCH and PDSCH transmissions associated with CORESETPoolIndex=1 (e.g. received from CORESET #4 or CORESET #5) shall be rate matched around the SSB associated with PCID #2.

If the UE receives a DCI format 1_2 with TCI field value (i.e. TCI codepoint) 011 from CORESET #4 (having CORESETPoolIndex=1), the TCI field value 011 indicates DL TCI-State #54 as the DL TCI state for CORESETPoolIndex=1. Accordingly, all the PDCCH and PDSCH transmissions associated with CORESETPoolIndex=1 (e.g. received from CORESET #4 or CORESET #5) shall be rate matched around the SSB associated with PCID #3.

For inter-cell multi-TRP (e.g. two TRPs) configured with unified TCI framework, two DL or joint TCI states associated with different CORESETPoolIndex values are indicated or activated to the UE, where each DL or joint TCI state determines a beam to each TRP. When the UE receives DL data from a non-serving cell, the UE can still receive short message (e.g. paging information or system information) from the serving cell when only one of the two indicated or activated (DL or joint) TCI states is associated with a PCID of the non-serving cell. It means that the other of the two indicated or activated (DL or joint) TCI states is associated with the PCID of the serving cell. According to the second embodiment, at least one of the two indicated or activated (DL or joint) TCI states which can be associated with CORESETPoolIndex=0 and/or CORESETPoolIndex=1 should be associated with the PCID of the serving cell so that the UE can receive short message (e.g. paging information or system information) from the serving cell.

A third embodiment relates to ACK/NACK mechanism in multi-DCI based multi-TRP DL transmission.

Note that ACK/NACK means ACK or NACK. For example, ACK/NACK for DCI means ACK for DCI (i.e. DCI is successfully received) or NACK for DCI (i.e. DCI is not successfully received).

In single-TRP scenario, ACK/NACK for DCI indicating unified TCI state is supported as follows.

If the TCI state is indicated by a DCI format 1_1 or 1_2 with DL assignment, the ACK/NACK of the PDSCH transmission scheduled by the DCI carrying the beam indication (i.e. TCI state indicating the beam) can be also used as an ACK/NACK for the DCI. If the TCI state is indicated by a DCI format 1_1 or 1_2 without DL assignment, upon a successful reception of the TCI indication DCI, the UE reports an ACK, otherwise the UE reports a NACK. The bit to indicate ACK or NACK (i.e. HARQ-ACK bit) shall be reported based on a virtual PDSCH indicated by the TDRA (time domain resource allocation) field and the PRI (PUCCH resource indicator) field of the TCI indication DCI. The TDRA field indicates the time domain resources used for the scheduled PDSCH transmission and the PRI field indicates a PUCCH resource used for the ACK/NACK feedback for the scheduled PDSCH transmission.

At least one HARQ-ACK bit is necessary for ACK/NACK of one PDSCH or PDCCH transmission. Multiple HARQ-ACK bits for multiple PDSCH and/or PDCCH transmissions can be contained in a HARQ-ACK codebook, which can be sent by being included in a PUCCH transmission indicated by the PRI field of the DCI.

In single-TRP scenario, the HARQ-ACK bit for the DCI indicating unified TCI state may be contained in a HARQ-ACK codebook to be transmitted to the single TRP.

In multi-TRP (e.g. multi-DCI based multi-TRP) scenario, ACK/NACK feedback can be for one DCI indicating a unified TCI state for any of multiple TRPs (e.g. two TRPs).

So, HARQ-ACK bits for DCIs indicating a unified TCI state for each TRP (i.e. associated with a CORESETPoolIndex value identifying the TRP) can be contained in a separate HARQ-ACK codebook. That is, HARQ-ACK bit for the DCI indicating a unified TCI state for a TRP associated with a CORESETPoolIndex value (e.g. associated with CORESETPoolIndex=0) can be contained in one HARQ-ACK codebook associated with the same CORESETPoolIndex value (e.g. CORESETPoolIndex=0) and sent to the one TRP associated with the same CORESETPoolIndex value (e.g. CORESETPoolIndex=0), while HARQ-ACK bit for the DCI indicating a unified TCI state for another TRP associated with another CORESETPoolIndex value (e.g. associated with CORESETPoolIndex=1) can be contained in another HARQ-ACK codebook associated with the same CORESETPoolIndex value (e.g. CORESETPoolIndex=1) and sent to the other TRP associated with the same CORESETPoolIndex value (e.g. CORESETPoolIndex=1). This manner of reporting ACK/NACK feedback for the DCI indicating a unified TCI state can be referred to as separate ACK/NACK feedback mode, which should at least be supported by the UE.

Alternatively, ACK/NACK feedback(s) for the DCI(s) indicating a unified TCI state for any TRP (e.g. any of the two TRPs, i.e. associated with either CORESETPoolIndex=0 or CORESETPoolIndex=1) can be reported in a joint ACK/NACK feedback mode, in which all HARQ-ACK bit(s) for the DCI(s) each of which indicates a unified TCI state for any of the TRPs (e.g. associated with either CORESETPoolIndex=0 or CORESETPoolIndex=1) may be contained in one HARQ-ACK codebook, and sent to either one TRP associated with CORESETPoolIndex=0 or the other TRP associated with CORESETPoolIndex=1.

Joint ACK/NACK feedback mode can be optionally supported according to UE capability (on whether the UE supports joint ACK/NACK feedback mode), since if the HARQ-ACK bits for one TRP is reported to another TRP, additional delay (e.g. backhaul delay) is required to transmit the HARQ-ACK bits for one TRP from the other TRP to the one TRP.

Incidentally, the DCI indicating a unified TCI state for a TRP associated with any CORESETPoolIndex value may alternatively be individually reported. That is, the HARQ-ACK bit for each DCI indicating a unified TCI state for one TRP associated with one CORESETPoolIndex value is reported to the one TRP associated with the one CORESETPoolIndex value, instead of being reported by being contained in a HARQ-ACK codebook. In this condition, no additional delay, i.e. no backhaul delay, is necessary.

Beam application time (BAT) is defined as the time duration between the last symbol of the acknowledgment of the joint or separate DL/UL TCI indication by DCI and the first slot to apply the indicated TCI state. If the HARQ-ACK bit is contained in a joint HARQ-ACK codebook, the backhaul delay between different TRPs should be considered.

For example, when HARQ-ACK bit for DCI indicating a unified TCI state for one TRP (e.g. TRP #1) is reported to another TRP (e.g. TRP #2), the backhaul delay refers to the time duration for the other TRP (e.g. TRP #2) to transmit the HARQ-ACK bit for DCI indicating a unified TCI state for one TRP (e.g. TRP #1) to the one TRP (e.g. TRP #1).

Suppose Y symbols is common BAT value, D symbols is the backhaul delay, Y and D can be configured to the UE. When the HARQ-ACK bit for DCI indicating unified TCI state is reported in the separate ACK/NACK feedback mode, Y symbols is taken as the BAT. When the HARQ-ACK bit for DCI indicating unified TCI state is reported in the joint ACK/NACK feedback mode, Y+D symbols is taken as the BAT. Incidentally, if the HARQ-ACK bit for DCI indicating a unified TCI state is individually reported, no matter whether the separate ACK/NACK feedback mode or the joint ACK/NACK feedback mode Y is configured, Y symbols is taken as the BAT. As a whole, one BAT value (e.g. Y symbols) is for separate ACK/NACK feedback (including individually reporting the HARQ-ACK bit for DCI indicating a unified TCI state), and the sum (e.g. Y+D symbols) of one BAT value (e.g. Y symbols) and the other BAT value (e.g. D symbols) is for joint ACK/NACK feedback.

Alternatively to configuring a common BAT value (e.g. Y symbols) and a backhaul delay (e.g. D symbols), two different BAT values (Y1 symbols and Y2 symbols) corresponding respectively to separate ACK/NACK feedback mode (including individually reporting the HARQ-ACK bit for DCI indicating a unified TCI state) and joint ACK/NACK feedback mode can be configured for the UE. When the separate ACK/NACK feedback mode is configured, the BAT corresponding to the separate ACK/NACK feedback mode (e.g. Y1 symbols=Y symbols) shall be applied. When the joint ACK/NACK feedback mode is configured, if the HARQ-ACK bit for DCI indicating TCI state is reported in a joint HARQ-ACK codebook, the BAT corresponding to joint ACK/NACK feedback mode (e.g. Y2 symbols=Y+D symbols) shall be applied; Otherwise (if the HARQ-ACK bit for DCI indicating unified TCI state is individually reported), the BAT corresponding to separate ACK/NACK feedback mode (e.g. Y1 symbols=Y symbols) shall be applied.

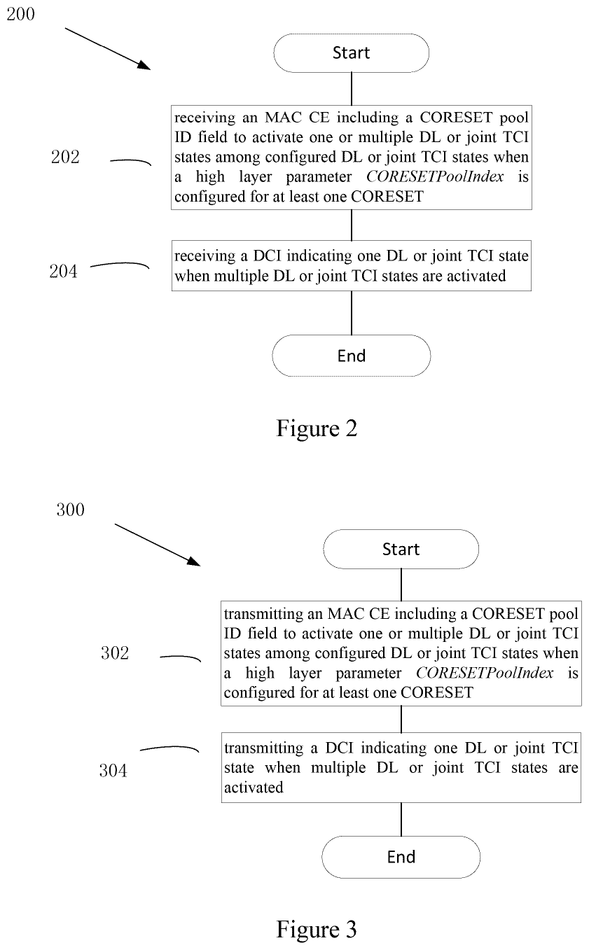

FIG. 2 is a schematic flow chart diagram illustrating an embodiment of a method 200 according to the present application. In some embodiments, the method 200 is performed by an apparatus, such as a remote unit (e.g. UE). In certain embodiments, the method 200 may be performed by a processor executing program code, for example, a microcontroller, a microprocessor, a CPU, a GPU, an auxiliary processing unit, a FPGA, or the like.

The method 200 is a method of a UE, comprising: 202 receiving an MAC CE including a CORESET pool ID field to activate one or multiple DL or joint TCI states among configured DL or joint TCI states when a high layer parameter CORESETPoolIndex is configured for at least one CORESET; and 204 receiving a DCI indicating one DL or joint TCI state when multiple DL or joint TCI states are activated.

In one embodiment, when one DL or joint TCI state is activated by the MAC CE, the one DL or joint TCI state is associated with the CORESETPoolIndex indicated by CORESET pool ID field included in the MAC CE.

In another embodiment, when multiple DL or joint TCI states are activated by the MAC CE, the activated multiple DL or joint TCI states are mapped to TCI codepoints indicated by DCI format 1_1 or 1_2 carried by PDCCH received from any CORESET(s) configured with the CORESETPoolIndex value that is the same as that indicated by the CORESET pool ID field included in the MAC CE. In particular, one of the activated multiple DL or joint TCI states is indicated by a DCI format 1_1 or 1_2 carried by PDCCH received from any CORESET configured with CORESETPoolIndex having the same value as that indicated by the CORESET Pool ID field value, and is associated with the same CORESETPoolIndex value configured for the CORESET.

In some embodiment, the method further comprises determining the TCI state for PDCCH transmission, PDSCH transmission, SPS PDSCH transmission and AP CSI-RS for beam management or channel state information acquisition according to the CORESETPoolIndex value. In particular, the activated or indicated TCI state is applied to PDCCH transmission and the respective PDSCH transmission received from the CORESET configured with the same CORESETPoolIndex associated with the activated or indicated TCI state; SPS PDSCH transmission activated by a DCI carried by PDCCH received from the CORESET configured with the same CORESETPoolIndex associated with the activated or indicated TCI state; and AP CSI-RS resources for beam management or channel state information acquisition and triggered by a DCI carried by PDCCH received from the CORESET configured with the same CORESETPoolIndex associated with the activated or indicated TCI state, where the CORESET is any CORESET other than CORESET #0 and is associated with only UE-specific search space, wherein, when only one DL or joint TCI state is activated by the MAC CE, the activated or indicated TCI state is the one activated DL or joint TCI state; and when multiple DL or joint TCI states are activated by the MAC CE, the activated or indicated TCI state is the indicated one DL or joint TCI state by the DCI.

In some embodiment, the activated TCI states associated with a CORESETPoolIndex value are associated with different PCID values.

In some embodiment, when a single activated or indicated TCI state is associated with a PCID of a non-serving cell, the PDCCH and PDSCH transmissions received from the CORESET having the same CORESETPoolIndex value as the single activated or indicated TCI state are rate matched around SSB associated with the non-serving PCID.

In some embodiment, when a single activated or indicated TCI state associated with one CORESETPoolIndex value is associated with a PCID of a non-serving cell, the single activated or indicated TCI state associated with the other CORESETPoolIndex value is associated with the PCID of the serving cell.

In some embodiment, the method further comprises transmitting a UE capability indicates whether reporting HARQ-ACK bit for DCI indicating unified TCI state in a joint HARQ-ACK codebook is supported. In addition, the method further comprises receiving a configuration with two BAT values for a cell when the UE capability indicates that reporting the HARQ-ACK bit for DCI indicating TCI state in a joint HARQ-ACK codebook is supported, where one BAT value is for separate ACK/NACK feedback and the other BAT value is for joint ACK/NACK feedback, or one BAT value is for separate ACK/NACK feedback and the sum of the one BAT value and the other BAT value is for joint ACK/NACK feedback. In particular, when a joint ACK/NACK feedback mode is configured, if the ACK/NACK bits for DCIs each of which indicates a unified TCI state is reported in a joint HARQ-ACK codebook, the BAT value for joint ACK/NACK feedback is applied; and if the ACK/NACK bit for each DCI indicating a unified TCI state is reported individually, the BAT value for separate ACK/NACK feedback is applied.

FIG. 3 is a schematic flow chart diagram illustrating an embodiment of a method 300 according to the present application. In some embodiments, the method 300 is performed by an apparatus, such as a base unit. In certain embodiments, the method 300 may be performed by a processor executing program code, for example, a microcontroller, a microprocessor, a CPU, a GPU, an auxiliary processing unit, a FPGA, or the like.

The method 300 may comprise 302 transmitting an MAC CE including a CORESET pool ID field to activate one or multiple DL or joint TCI states among configured DL or joint TCI states when a high layer parameter CORESETPoolIndex is configured for at least one CORESET; and 304 transmitting a DCI indicating one DL or joint TCI state when multiple DL or joint TCI states are activated.

In one embodiment, when one DL or joint TCI state is activated by the MAC CE, the one DL or joint TCI state is associated with the CORESETPoolIndex indicated by CORESET pool ID field included in the MAC CE.

In another embodiment, when multiple DL or joint TCI states are activated by the MAC CE, the activated multiple DL or joint TCI states are mapped to TCI codepoints indicated by DCI format 1_1 or 1_2 carried by PDCCH transmitted from any CORESET(s) configured with the CORESETPoolIndex value that is the same as that indicated by the CORESET pool ID field included in the MAC CE. In particular, one of the activated multiple DL or joint TCI states is indicated by a DCI format 1_1 or 1_2 carried by PDCCH transmitted from any CORESET configured with CORESETPoolIndex having the same value as that indicated by the CORESET Pool ID field value, and is associated with the same CORESETPoolIndex value configured for the CORESET.

In some embodiment, the method further comprises determining the TCI state for PDCCH transmission, PDSCH transmission, SPS PDSCH transmission and AP CSI-RS for beam management or channel state information acquisition according to the CORESETPoolIndex value. In particular, the activated or indicated TCI state is applied to PDCCH transmission and the respective PDSCH transmission transmitted from the CORESET configured with the same CORESETPoolIndex associated with the activated or indicated TCI state; SPS PDSCH transmission activated by a DCI carried by PDCCH transmitted from the CORESET configured with the same CORESETPoolIndex associated with the activated or indicated TCI state; and AP CSI-RS resources for beam management or channel state information acquisition and triggered by a DCI carried by PDCCH transmitted from the CORESET configured with the same CORESETPoolIndex associated with the activated or indicated TCI state, where the CORESET is any CORESET other than CORESET #0 and is associated with only UE-specific search space, wherein, when only one DL or joint TCI state is activated by the MAC CE, the activated or indicated TCI state is the one activated DL or joint TCI state; and when multiple DL or joint TCI states are activated by the MAC CE, the activated or indicated TCI state is the indicated one DL or joint TCI state by the DCI.

In some embodiment, the activated TCI states associated with a CORESETPoolIndex value are associated with different PCID values.

In some embodiment, when a single activated or indicated TCI state associated with one CORESETPoolIndex value is associated with a PCID of a non-serving cell, the single activated or indicated TCI state associated with the other CORESETPoolIndex value is associated with the PCID of the serving cell.

In some embodiment, the method further comprises receiving a UE capability indicates whether reporting HARQ-ACK bit for DCI indicating unified TCI state in a joint HARQ-ACK codebook is supported. In addition, the method further comprises transmitting a configuration with two BAT values for a cell when the UE capability indicates that reporting the HARQ-ACK bit for DCI indicating TCI state in a joint HARQ-ACK codebook is supported, where one BAT value is for separate ACK/NACK feedback and the other BAT value is for joint ACK/NACK feedback, or one BAT value is for separate ACK/NACK feedback and the sum of the one BAT value and the other BAT value is for joint ACK/NACK feedback. In particular, when a joint ACK/NACK feedback mode is configured, if the ACK/NACK bits for DCIs each of which indicates a unified TCI state is reported in a joint HARQ-ACK codebook, the BAT value for joint ACK/NACK feedback is applied; and if the ACK/NACK bit for each DCI indicating a unified TCI state is reported individually, the BAT value for separate ACK/NACK feedback is applied.

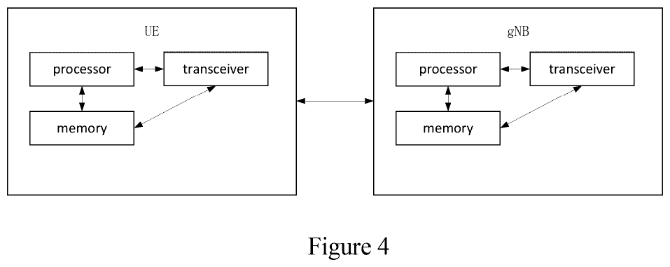

FIG. 4 is a schematic block diagram illustrating apparatuses according to one embodiment.

Referring to FIG. 4, the UE (i.e. the remote unit) includes a processor, a memory, and a transceiver. The processor implements a function, a process, and/or a method which are proposed in FIG. 2.

The UE comprises a processor; and a transceiver coupled to the processor, wherein the processor is configured to receive, via the transceiver, an MAC CE including a CORESET pool ID field to activate one or multiple DL or joint TCI states among configured DL or joint TCI states when a high layer parameter CORESETPoolIndex is configured for at least one CORESET; and receive, via the transceiver, a DCI indicating one DL or joint TCI state when multiple DL or joint TCI states are activated.

In one embodiment, when one DL or joint TCI state is activated by the MAC CE, the one DL or joint TCI state is associated with the CORESETPoolIndex indicated by CORESET pool ID field included in the MAC CE.

In another embodiment, when multiple DL or joint TCI states are activated by the MAC CE, the activated multiple DL or joint TCI states are mapped to TCI codepoints indicated by DCI format 1_1 or 1_2 carried by PDCCH received from any CORESET(s) configured with the CORESETPoolIndex value that is the same as that indicated by the CORESET pool ID field included in the MAC CE. In particular, one of the activated multiple DL or joint TCI states is indicated by a DCI format 1_1 or 1_2 carried by PDCCH received from any CORESET configured with CORESETPoolIndex having the same value as that indicated by the CORESET Pool ID field value, and is associated with the same CORESETPoolIndex value configured for the CORESET.

In some embodiment, the processor is further configured to determine the TCI state for PDCCH transmission, PDSCH transmission, SPS PDSCH transmission and AP CSI-RS for beam management or channel state information acquisition according to the CORESETPoolIndex value. In particular, the processor is configured to apply the activated or indicated TCI state to PDCCH transmission and the respective PDSCH transmission received from the CORESET configured with the same CORESETPoolIndex associated with the activated or indicated TCI state; SPS PDSCH transmission activated by a DCI carried by PDCCH received from the CORESET configured with the same CORESETPoolIndex associated with the activated or indicated TCI state; and AP CSI-RS resources for beam management or channel state information acquisition and triggered by a DCI carried by PDCCH received from the CORESET configured with the same CORESETPoolIndex associated with the activated or indicated TCI state, where the CORESET is any CORESET other than CORESET #0 and is associated with only UE-specific search space, wherein, when only one DL or joint TCI state is activated by the MAC CE, the activated or indicated TCI state is the one activated DL or joint TCI state; and when multiple DL or joint TCI states are activated by the MAC CE, the activated or indicated TCI state is the indicated one DL or joint TCI state by the DCI.

In some embodiment, the activated TCI states associated with a CORESETPoolIndex value are associated with different PCID values.

In some embodiment, when a single activated or indicated TCI state is associated with a PCID of a non-serving cell, the PDCCH and PDSCH transmissions received from the CORESET having the same CORESETPoolIndex value as the single activated or indicated TCI state are rate matched around SSB associated with the non-serving PCID.

In some embodiment, when a single activated or indicated TCI state associated with one CORESETPoolIndex value is associated with a PCID of a non-serving cell, the single activated or indicated TCI state associated with the other CORESETPoolIndex value is associated with the PCID of the serving cell.

In some embodiment, the processor is further configured to transmit, via the transceiver, a UE capability indicates whether reporting HARQ-ACK bit for DCI indicating unified TCI state in a joint HARQ-ACK codebook is supported. In addition, the processor is further configured to receive, via the transceiver, a configuration with two BAT values for a cell when the UE capability indicates that reporting the HARQ-ACK bit for DCI indicating TCI state in a joint HARQ-ACK codebook is supported, where one BAT value is for separate ACK/NACK feedback and the other BAT value is for joint ACK/NACK feedback, or one BAT value is for separate ACK/NACK feedback and the sum of the one BAT value and the other BAT value is for joint ACK/NACK feedback. In particular, when a joint ACK/NACK feedback mode is configured, if the ACK/NACK bits for DCIs each of which indicates a unified TCI state is reported in a joint HARQ-ACK codebook, the BAT value for joint ACK/NACK feedback is applied; and if the ACK/NACK bit for each DCI indicating a unified TCI state is reported individually, the BAT value for separate ACK/NACK feedback is applied.

The gNB (i.e. the base unit) includes a processor, a memory, and a transceiver. The processor implements a function, a process, and/or a method which are proposed in FIG. 3.

The base unit comprises a processor; and a transceiver coupled to the processor, wherein the processor is configured to transmit, via the transceiver, an MAC CE including a CORESET pool ID field to activate one or multiple DL or joint TCI states among configured DL or joint TCI states; and transmit, via the transceiver, a DCI indicating one DL or joint TCI state when multiple DL or joint TCI states are activated.

In one embodiment, when one DL or joint TCI state is activated by the MAC CE, the one DL or joint TCI state is associated with the CORESETPoolIndex indicated by CORESET pool ID field included in the MAC CE.

In another embodiment, when multiple DL or joint TCI states are activated by the MAC CE, the activated multiple DL or joint TCI states are mapped to TCI codepoints indicated by DCI format 1_1 or 1_2 carried by PDCCH transmitted from any CORESET(s) configured with the CORESETPoolIndex value that is the same as that indicated by the CORESET pool ID field included in the MAC CE. In particular, one of the activated multiple DL or joint TCI states is indicated by a DCI format 1_1 or 1_2 carried by PDCCH transmitted from any CORESET configured with CORESETPoolIndex having the same value as that indicated by the CORESET Pool ID field value, and is associated with the same CORESETPoolIndex value configured for the CORESET.

In some embodiment, the processor is further configured to determine the TCI state for PDCCH transmission, PDSCH transmission, SPS PDSCH transmission and AP CSI-RS for beam management or channel state information acquisition according to the CORESETPoolIndex value. In particular, the processor is configured to determine that the activated or indicated TCI state is applied to PDCCH transmission and the respective PDSCH transmission transmitted from the CORESET configured with the same CORESETPoolIndex associated with the activated or indicated TCI state; SPS PDSCH transmission activated by a DCI carried by PDCCH transmitted from the CORESET configured with the same CORESETPoolIndex associated with the activated or indicated TCI state; and AP CSI-RS resources for beam management or channel state information acquisition and triggered by a DCI carried by PDCCH transmitted from the CORESET configured with the same CORESETPoolIndex associated with the activated or indicated TCI state, where the CORESET is any CORESET other than CORESET #0 and is associated with only UE-specific search space, wherein, when only one DL or joint TCI state is activated by the MAC CE, the activated or indicated TCI state is the one activated DL or joint TCI state; and when multiple DL or joint TCI states are activated by the MAC CE, the activated or indicated TCI state is the indicated one DL or joint TCI state by the DCI.

In some embodiment, the activated TCI states associated with a CORESETPoolIndex value are associated with different PCID values.

In some embodiment, when a single activated or indicated TCI state associated with one CORESETPoolIndex value is associated with a PCID of a non-serving cell, the single activated or indicated TCI state associated with the other CORESETPoolIndex value is associated with the PCID of the serving cell.

In some embodiment, the processor is further configured to receive, via the transceiver, a UE capability indicates whether reporting HARQ-ACK bit for DCI indicating unified TCI state in a joint HARQ-ACK codebook is supported. In addition, the processor is further configured to transmit, via the transceiver, a configuration with two BAT values for a cell when the UE capability indicates that reporting the HARQ-ACK bit for DCI indicating TCI state in a joint HARQ-ACK codebook is supported, where one BAT value is for separate ACK/NACK feedback and the other BAT value is for joint ACK/NACK feedback, or one BAT value is for separate ACK/NACK feedback and the sum of the one BAT value and the other BAT value is for joint ACK/NACK feedback. In particular, when a joint ACK/NACK feedback mode is configured, if the ACK/NACK bits for DCIs each of which indicates a unified TCI state is reported in a joint HARQ-ACK codebook, the BAT value for joint ACK/NACK feedback is applied; and if the ACK/NACK bit for each DCI indicating a unified TCI state is reported individually, the BAT value for separate ACK/NACK feedback is applied.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

1. A user equipment (UE) for wireless communication, comprising:
at least one memory; and
at least one processor coupled with the at least one memory and configured to cause the UE to:
receive a medium access control (MAC) control element (CE) including a control resource set (CORESET) pool ID field to activate one or multiple downlink (DL) or joint transmission configuration indication (TCI) states among configured DL or joint TCI states when a high layer parameter CORESETPoolIndex is configured for at least one CORESET; and
receive downlink control information (DCI) indicating one DL or joint TCI state when multiple DL or joint TCI states are activated.

2. The UE of claim 1, wherein, when one DL or joint TCI state is activated by the MAC CE, the one DL or joint TCI state is associated with the CORESETPoolIndex indicated by CORESET pool ID field included in the MAC CE.

3. The UE of claim 1, wherein, when multiple DL or joint TCI states are activated by the MAC CE, the activated multiple DL or joint TCI states are mapped to TCI codepoints indicated by DCI format 1_1 or 1_2 carried by physical downlink control channel (PDCCH) received from any CORESET(s) configured with the CORESETPoolIndex value that is the same as that indicated by the CORESET pool ID field included in the MAC CE.

4. The UE of claim 3, wherein, one of the activated multiple DL or joint TCI states is indicated by a DCI format 1_1 or 1_2 carried by PDCCH received from any CORESET configured with CORESETPoolIndex having the same value as that indicated by the CORESET Pool ID field value, and is associated with the same CORESETPoolIndex value configured for the CORESET.

5. The UE of claim 1, wherein, the at least one processor is further configured to cause the UE to: determine the TCI state for physical downlink control channel (PDCCH) transmission, physical downlink shared channel (PDSCH) transmission, semi-persistent scheduling (SPS) PDSCH transmission and access point (AP) channel state information reference signal (CSI-RS) for beam management or channel state information acquisition according to the CORESETPoolIndex value.

6. The UE of claim 5, wherein, the at least one processor is further configured to cause the UE to apply the activated or indicated TCI state to:
PDCCH transmission and the respective PDSCH transmission received from the CORESET configured with the same CORESETPoolIndex associated with the activated or indicated TCI state;
SPS PDSCH transmission activated by a DCI carried by PDCCH received from the CORESET configured with the same CORESETPoolIndex associated with the activated or indicated TCI state; and
AP CSI-RS resources for beam management or channel state information acquisition and triggered by a DCI carried by PDCCH received from the CORESET configured with the same CORESETPoolIndex associated with the activated or indicated TCI state,
wherein the CORESET is any CORESET other than CORESET #0 and is associated with only UE-specific search space,
wherein, when only one DL or joint TCI state is activated by the MAC CE, the activated or indicated TCI state is the one activated DL or joint TCI state; and when multiple DL or joint TCI states are activated by the MAC CE, the activated or indicated TCI state is the indicated one DL or joint TCI state by the DCI.

7. The UE of claim 1, wherein, the activated TCI states associated with a CORESETPoolIndex value are associated with different physical cell ID (PCID) values.

8. The UE of claim 1, wherein, when a single activated or indicated TCI state is associated with a physical cell ID (PCID) of a non-serving cell, physical downlink control channel (PDCCH) and physical downlink shared channel (PDSCH) transmissions received from the CORESET having a same CORESETPoolIndex value as the single activated or indicated TCI state are rate matched around a synchronization signal block (SSB) associated with the non-serving PCID.

9. The UE of claim 1, wherein, when a single activated or indicated TCI state associated with one CORESETPoolIndex value is associated with a physical cell ID (PCID) of a non-serving cell, the single activated or indicated TCI state associated with the other CORESETPoolIndex value is associated with the PCID of the serving cell.

10. The UE of claim 1, wherein, the at least one processor is further configured to cause the UE to transmit, via the transceiver, a UE capability indicates whether reporting a hybrid automatic repeat request acknowledge (HARQ-ACK) bit for DCI indicating unified TCI state in a joint HARQ-ACK codebook is supported.

11. The UE of claim 10, wherein, the at least one processor is further configured to cause the UE to receive, via the transceiver, a configuration with two beam application time (BAT) values for a cell when the UE capability indicates that reporting the HARQ-ACK bit for DCI indicating TCI state in a joint HARQ-ACK codebook is supported, where one BAT value is for separate acknowledge/negative acknowledge (ACK/NACK) feedback and the other BAT value is for joint ACK/NACK feedback, or one BAT value is for separate ACK/NACK feedback and the sum of the one BAT value and the other BAT value is for joint ACK/NACK feedback.

12. The UE of claim 11, wherein, when a joint ACK/NACK feedback mode is configured,
if the ACK/NACK bits for DCIs each of which indicates a unified TCI state is reported in a joint HARQ-ACK codebook, the BAT value for joint ACK/NACK feedback is applied; and
if the ACK/NACK bit for each DCI indicating a unified TCI state is reported individually, the BAT value for separate ACK/NACK feedback is applied.

13. A method performed by a user equipment (UE), the method comprising:
receiving a medium access control (MAC) control element (CE) including a control resource set (CORESET) pool ID field to activate one or multiple downlink (DL) or joint transmission configuration indication (TCI) states among configured DL or joint TCI states when a high layer parameter CORESETPoolIndex is configured for at least one CORESET; and
receiving downlink control information (DCI) indicating one DL or joint TCI state when multiple DL or joint TCI states are activated.

14. (canceled)

15. The method of claim 13, further comprising:
determining the TCI state for physical downlink control channel (PDCCH) transmission, physical downlink shared channel (PDSCH) transmission, semi-persistent scheduling (SPS) PDSCH transmission and access point (AP) channel state information reference signal (CSI-RS) for beam management or channel state information acquisition according to the CORESETPoolIndex value.

16. The method of claim 15, wherein applying the activated or indicated TCI state comprises:
PDCCH transmission and the respective PDSCH transmission received from the CORESET configured with the same CORESETPoolIndex associated with the activated or indicated TCI state;
SPS PDSCH transmission activated by a DCI carried by PDCCH received from the CORESET configured with the same CORESETPoolIndex associated with the activated or indicated TCI state; and
AP CSI-RS resources for beam management or channel state information acquisition and triggered by a DCI carried by PDCCH received from the CORESET configured with the same CORESETPoolIndex associated with the activated or indicated TCI state,
wherein the CORESET is any CORESET other than CORESET #0 and is associated with only UE-specific search space, and
wherein, when only one DL or joint TCI state is activated by the MAC CE, the activated or indicated TCI state is the one activated DL or joint TCI state; and when multiple DL or joint TCI states are activated by the MAC CE, the activated or indicated TCI state is the indicated one DL or joint TCI state by the DCI.

17. A network entity for wireless communication, comprising:
at least one memory; and
at least one processor coupled with the at least one memory and configured to cause the network entity to:
transmit a medium access control (MAC) control element (CE) including a control resource set (CORESET) pool ID field to activate one or multiple downlink (DL) or joint transmission configuration indication (TCI) states among configured DL or joint TCI states; and
transmit downlink control information (DCI) indicating one DL or joint TCI state when multiple DL or joint TCI states are activated.

18. A processor for wireless communication, comprising:
at least one controller coupled with the at least one processor and configured to cause the processor to:
receive a medium access control (MAC) control element (CE) including a control resource set (CORESET) pool ID field to activate one or multiple downlink (DL) or joint transmission configuration indication (TCI) states among configured DL or joint TCI states when a high layer parameter CORESETPoolIndex is configured for at least one CORESET; and
receive downlink control information (DCI) indicating one DL or joint TCI state when multiple DL or joint TCI states are activated.

19. The processor of claim 18, wherein when one DL or joint TCI state is activated by the MAC CE, the one DL or joint TCI state is associated with the CORESETPoolIndex indicated by CORESET pool ID field included in the MAC CE.

20. The processor of claim 18, wherein the at least one controller is further configured to cause the processor to: determine the TCI state for physical downlink control channel (PDCCH) transmission, physical downlink shared channel (PDSCH) transmission, semi-persistent scheduling (SPS) PDSCH transmission and access point (AP) channel state information reference signal (CSI-RS) for beam management or channel state information acquisition according to the CORESETPoolIndex value.

21. The processor of claim 20, wherein the at least one controller is further configured to cause the processor to apply the activated or indicated TCI state to:
PDCCH transmission and the respective PDSCH transmission received from the CORESET configured with the same CORESETPoolIndex associated with the activated or indicated TCI state;
SPS PDSCH transmission activated by a DCI carried by PDCCH received from the CORESET configured with the same CORESETPoolIndex associated with the activated or indicated TCI state; and
AP CSI-RS resources for beam management or channel state information acquisition and triggered by a DCI carried by PDCCH received from the CORESET configured with the same CORESETPoolIndex associated with the activated or indicated TCI state,
wherein the CORESET is any CORESET other than CORESET #0 and is associated with only UE-specific search space,
wherein, when only one DL or joint TCI state is activated by the MAC CE, the activated or indicated TCI state is the one activated DL or joint TCI state; and when multiple DL or joint TCI states are activated by the MAC CE, the activated or indicated TCI state is the indicated one DL or joint TCI state by the DCI.
